(19) United States
(12) Patent Application Publication
(10) Pub. No.: US 2016/0344263 A1
(43) Pub. Date: Nov. 24, 2016

(54) ELECTRIC MACHINE

(71) Applicant: MAGNA POWERTRAIN GMBH & CO KG, Lannach (AU)

(72) Inventors: Wolfgang Back, Oftering (AT); Florian Faistauer, Steyr (AT); Klaus Nenninger, Perg (AT)

(21) Appl. No.: 15/114,899

(22) PCT Filed: Jan. 21, 2015
(86) PCT No.: PCT/EP2015/051149

§ 371 Date: Jul. 28, 2016

(30) Foreign Application Priority Data
Feb. 5, 2014 (DE) 102014202055.7

(51) Int. Cl. H02K 9/19; H02K 1/22; H02K 1/20; H02K 1/16

(52) U.S. Cl. CPC H02K 9/19; H02K 1/16; H02K 1/22; H02K 1/20

(57) ABSTRACT

An electric machine is described, having a stator and a rotatably mounted rotor which is surrounded by the stator, the stator having a laminated core, having a winding groove in the laminated core, which winding groove receives a winding, and at least one cooling ring which adjoins the laminated core in the region of the winding heads, a heat conduction tube in the form of a heat pipe being inserted in the winding groove between the winding and the bottom of the winding groove, the heat dissipation region of the heat conduction tube lying in the region of the cooling ring.

### CROSS-REFERENCE TO RELATED APPLICATIONS

This application is a U.S. National Stage of International Application No. PCT/EP2015/051149, filed Jan. 21, 2015 and which claims priority to German Application No. DE 10 2014 202 055.7 filed Feb. 5, 2014. The entire disclosure of each of the above listed applications is incorporated herein by reference.

### FIELD

The present invention relates to an electric machine, having a stator and a rotatably mounted rotor which is surrounded by the stator, the stator having a laminated core, having a winding groove in the laminated core, which winding groove receives a winding, and at least one cooling ring which adjoins the laminated core in the region of the winding heads.

### BACKGROUND

Electric machines having a rotor and a stator develop heat during operation, which heat is to be discharged from the inner region. In order to cool the stator, it is known to surround the laminated core of the stator with a cooling jacket. Here, the heat from the copper windings is discharged via the moderately thermally conducting laminated core into the cooling water of the cooling jacket.

DE 10 2005 002 564 A1 describes an electric machine having a stator which has windings. For the discharge of heat, heat pipes which transport heat into cooled flanges are arranged in the laminated core of the stator. Furthermore, the use of heat pipes in electric machines is known from DE 10 258 778 A1, US 2005156470 A1 and US 2008023177 A1.

DE 10 2009 051 114 A1 describes an electric machine having a hollow shaft of the rotor, which hollow shaft is configured as a closed cavity and is filled with a refrigerant. A three-dimensional transport structure which serves to transport the refrigerant is provided in the cavity. Electric machines having a hollow shaft for the transport of heat are known, furthermore, from DE 10 2007 043 656 A1 and GB 1 361 047 A.

### SUMMARY

The basis is the object of providing an electric machine in an improved form in comparison with the known solutions. In particular, the present invention is based on the object of developing an electric machine in such a way that more homogeneous temperature distribution and improved discharge of heat to a cooling medium is achieved, and that the external diameter of the electric machine is as small as possible despite effective cooling.

This object is achieved by way of an electric machine having the features of claim 1.

According to the invention, an electric machine is provided which has a stator, having a laminated core, a winding groove in the laminated core, which winding groove receives a winding, and at least one cooling ring which adjoins the laminated core in the region of the winding heads, a heat conduction tube in the form of a heat pipe being inserted in the winding groove between the winding (copper winding) and the bottom of the winding groove, the heat dissipation region of the heat conduction tube lying in the region of the cooling ring. Here, the heat dissipation region of the heat conduction tube can lie on an inner circumferential region of the cooling ring or else on a lateral region of the cooling ring.

During operation of the electric machine, the heat conduction tube which lies in the bottom of the winding groove discharges the heat which is produced in the copper winding in the direction of the cooling ring. Furthermore, the waste heat from the laminated core is discharged to the heat conduction tube and is forwarded via the heat conduction tube to the cooling ring. In the cooling ring, the heat is absorbed by way of the cooling liquid which flows in the cooling channel, and is transported away to a connected cooling device. Furthermore, the heat which is produced in the winding heads is also absorbed directly and discharged by way of the cooling rings. Improved heat discharge can be achieved by way of the above-described heat transfers and the corresponding discharge of the heat in the cooling ring. At the same time, a homogeneous temperature distribution is achieved in the stator.

It is provided in one preferred embodiment of the invention that the laminated core is delimited on both sides by in each case one cooling ring, and the heat conduction tube bears against in each case one cooling ring at both ends. As a result, a particularly effective heat discharge and a homogeneous temperature distribution are achieved. In particular, the motor performance can be increased by way of the special arrangement of the heat conduction tubes.

One preferred development of the invention provides here that the cooling ring is flowed through by a cooling liquid.

According to one development of the invention, the laminated core is surrounded by a motor housing between the cooling rings. As a result of the configuration according to the invention of the electric machine with the heat conduction tube which lies in the bottom of the winding groove of the stator, the heat conduction tube having at least one heat dissipation region which lies in the region of a cooling ring, the external diameter of the electric machine can be reduced. Although the grooves themselves have to have a greater depth as a result of the arrangement of the heat conduction tubes in the grooves and the diameter of the laminated core is increased as a result, the cooling jacket around the complete housing of the electric machine can be dispensed with.

In each case one cooling ring is arranged at the ends of the stator of the laminated core, which cooling ring has a channel which is flowed through by a cooling liquid. On its outer edge region, the cooling ring is in contact with a jacket-shaped motor housing which surrounds the laminated core of the stator. The motor housing does not have any cooling jacket or is not surrounded by any cooling jacket.

The heat conduction tube runs between the winding and the bottom of the winding groove. The heat conduction tube extends over the length of the laminated core of the stator and has in each case one heat dissipation region at both ends, which heat dissipation region ends on the inner side of the cooling ring in the region of the winding head and/or is in contact with the cooling ring.

The electric machine according to the invention is developed by virtue of the fact that the shaft which supports the rotor is for its part configured to be hollow and as a heat pipe (heat conduction tube). Waste or frictional heat is produced in the case of rotating machine parts, which heat can lead to thermal overloading of the component or of the associated bearing points. Improved thermal transport from the interior of the machine to the surface is achieved by way of the embodiment of the rotor of an electric machine as a heat conduction tube. In the case of heat conduction tubes for rotating components, the rotation or the centrifugal forces are utilized in a particularly advantageous way, in order to convey the condensate to the hot side (heat dissipation region).

The cavity of the rotor shaft is preferably provided on its inner wall with structuring which brings about the transport of the condensed cooling liquid as a result of the rotation.

Instead of a water jacket which surrounds the motor housing, the cooling concept according to the invention uses cooling rings which are arranged as directly as possible on the winding heads. Here, the heat of the winding heads can be conducted directly into the cooling rings. The waste heat from the interior of the stator, that is to say from the copper windings and the laminated core, is conducted in the direction of the cooling ring via the heat conduction tubes (heat pipes) which are arranged between the laminated core and the copper winding. The heat conduction tubes which run in the longitudinal direction in the bottom of the winding groove between the laminated core and the copper winding can absorb both heat from the copper windings and from the laminated core as a result of the abovementioned arrangement. A homogeneous temperature distribution is achieved in the stator by way of the embodiment according to the invention. A reduction in the external diameter of the electric machine can be achieved by way of the omission of a cooling jacket which surrounds the stator.

### DESCRIPTION OF THE DRAWINGS

Preferred embodiments of the electric machine will be described by way of example in the following text, reference being made illustratively to the appended drawings, in which:

FIG. 1 shows a section through a stator having heat conduction tubes which are arranged in the winding groove,

FIG. 2 shows a section through a rotor shaft which is configured as a heat conduction tube,

FIG. 3 shows a section through a rotor element which is configured as a heat conduction disc,

FIG. 4 shows a section through a further exemplary embodiment of a rotor shaft which is configured as a heat conduction tube,

FIG. 5 shows a perspective view of the sectional illustration according to FIG. 4, and

FIG. 6 shows a perspective view of a sectional illustration of a further configuration of a rotor shaft which is configured as a heat conduction tube.

### DETAILED DESCRIPTION

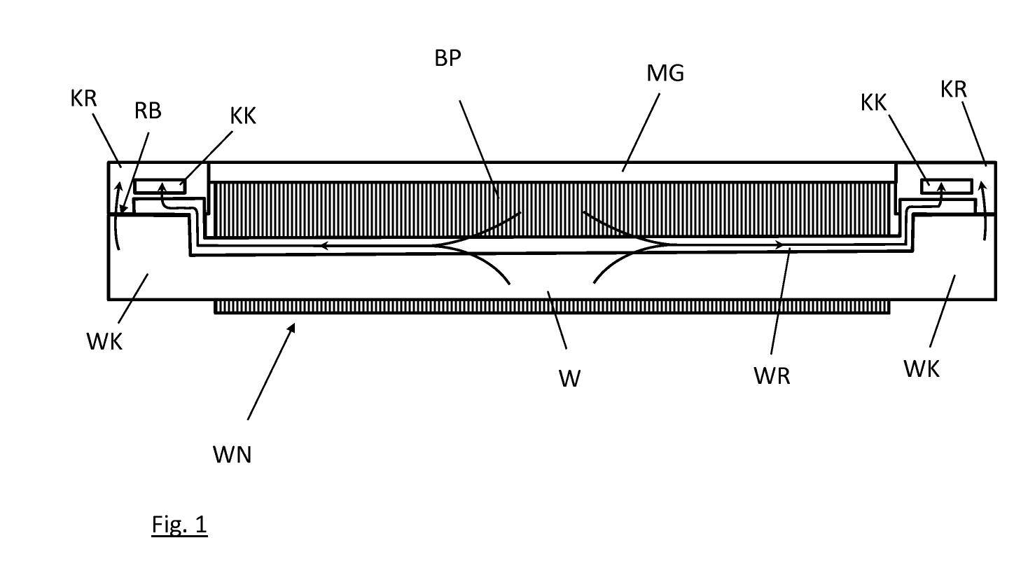

FIG. 1 shows a section through a stator of an electric machine (not shown in further detail). Here, the section leads centrally through the winding groove WN of a stator which surrounds a rotor (not shown). The winding groove WN runs in the axial direction of the rotor on the inner side of the laminated core BP which is formed by way of a multiplicity of discs and thus forms the tubular stator. The laminated core BP extends over the length of the stator.

The winding groove WN receives a strand of a winding, usually a copper winding W, which windings, forming winding heads WK at both ends of the stator, run to a next winding groove WN. The inner circumference of the stator of the laminated core BP therefore has a multiplicity of parallel winding grooves WN which receive the looped-through windings W.

In each case one cooling ring KR is arranged at the ends of the stator of the laminated core BP, which cooling ring KR has an annular channel which is flowed through by a cooling liquid. In each case at their edge region which faces the laminated core, the cooling rings KR are in contact with a jacket-shaped motor housing MG which surrounds the laminated core BP. The motor housing does not have an additional cooling jacket which surrounds the motor housing.

A heat conduction tube WR in the form of a heat pipe is inserted between the winding W and the bottom of the winding groove WN. The heat conduction tube WR extends over the length of the laminated core BP and has in each case one heat dissipation region at both ends, which heat dissipation region ends on the inner side of the cooling ring KR in the region of the winding head WK.

The heat conduction tube discharges the heat which is produced in the copper winding W and in the laminated core BP in the direction of its ends to the cooling rings KR. Heat conduction tubes are fundamentally already known and will not be described in detail at this point. In summary, heat conduction tubes are closed tubes which are filled partially with water and in which a vacuum is set. As a result of the heat input of the copper winding and the laminated core, the water in the interior of the heat tube evaporates and flows to cooling surfaces, on which the steam condenses again. The condensate is conveyed back to the hot surfaces via capillary action.

As has already been described above, the heat is conducted to the ends of the heat conduction tubes (heat dissipation region) and is conducted there into the cooling rings KR. In the cooling rings KR, the heat is received and transported away by the cooling liquid which flows in the cooling channels. The heat transfers, starting from the copper winding W and the laminated core BP via the heat conduction tube WR to the cooling rings KR, is indicated by way of the arrows in the drawing. Furthermore, the heat which is produced in the winding heads WK is also directly absorbed and discharged by way of the cooling rings KR. As can be seen from the sectional illustration, the cooling rings and the winding heads lie directly on one another via an annular region RB. The heat transfer from the winding heads WK to the cooling rings via the annular region RB is likewise shown by way of arrows.

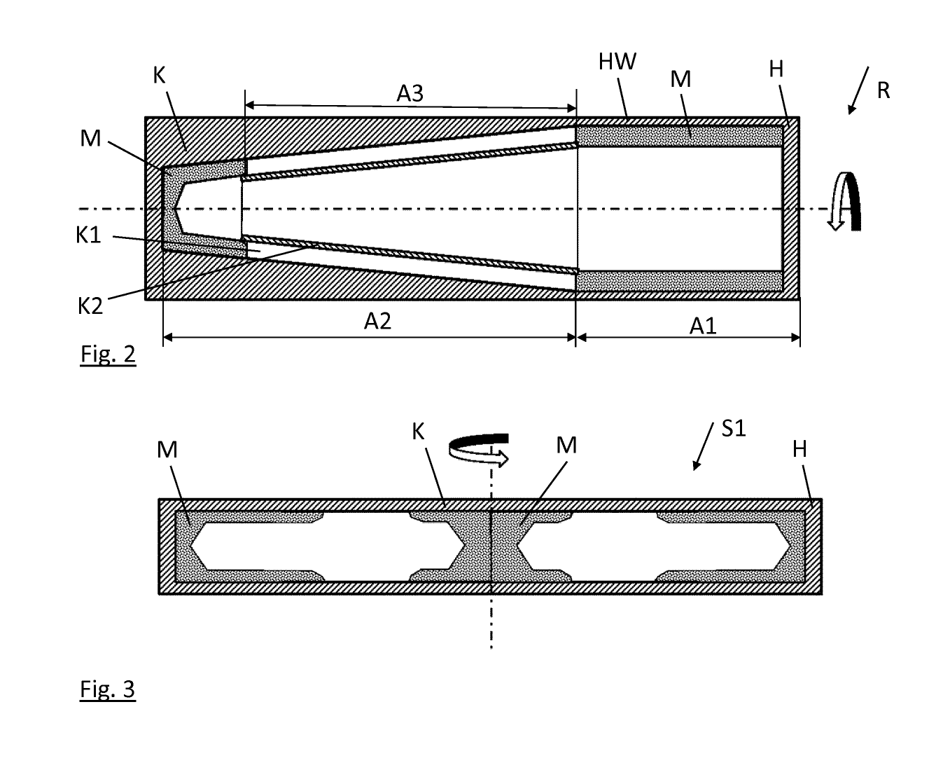

In the following text, embodiments of heat conduction tubes (heat pipes) which can be used as rotor shafts of the electric machine will be described using FIGS. 2 and 4-6. As has already been described above, heat conduction tubes consist of a closed cavity, in which a vacuum prevails and which contains a small quantity of water. On account of the prevailing vacuum, the water at the hot end already evaporates in the interior of the heat conduction tube at a low temperature level. The steam then flows to the cold end and condenses there. On account of the rotation and/or the centrifugal forces during operation of the rotor which is configured as a heat conduction tube, the condensate is conveyed to the hot side again.

FIG. 2 shows a first exemplary embodiment of a rotor R of an electric machine, which rotor R is configured as a heat conduction tube. The rotational axis is illustrated using a dash-dotted line. The rotation is indicated by way of the arrow. As has already been explained, the shaft is configured as a closed hollow shaft HW. The end regions of the shaft define the hot side and the cold side. The hot side H is arranged on the right-hand side of the drawing. In the region of the hot side, the cavity of the shaft has the greatest diameter and is of cylindrical configuration via a first section A1. The said first cylindrical section A1 is adjoined by a second conical section A2. It can be seen from the sectional illustration that the cone K1 is configured so as to taper towards the end region of the cold side K. A conical tube K2 is inserted along a section A3 in the section A2. The conical tube K2 is arranged concentrically with respect to the cone which is made in the shaft, and ends in section A2 at a spacing from the end region of the said cone. The arrangement of an additional tube K2 prevents impeding of the condensate flow by way of the steam flow.

Starting from the end regions of the conical tube K2 as far in each case as the inner end face of the cold region or the hot region, a metal mesh or a metal foam M is inserted on the inner circumferential face. This serves at the said locations to increase the surface area and therefore to improve the heat transfer.

In one exemplary embodiment which is not shown, the internal diameter of the hollow shaft can also be configured so as to run, starting from the hot side, in a stepped manner with a smaller diameter to the cold side.

As has already been explained, the hot side is arranged at the point of the greatest internal diameter. During operation of the hollow shaft as a rotor/rotor shaft in an electric machine, the water in the cavity flows on account of the centrifugal forces to the point of the greatest diameter. Heat is then added at the said point and evaporates the water which is situated in the cavity. Since water is resupplied by way of the configuration and arrangement of the conical section, the steam in the region of the hot side is driven away and flows to the points of the heat conduction tube with the smallest diameter, namely the cold side. The heat is then removed on the cold side, as a result of which the steam condenses. The condensate then flows via the gap between the inner conical circumferential face and the outer circumferential face of the conical tube K2 along section A3 back in the direction of the hot side.

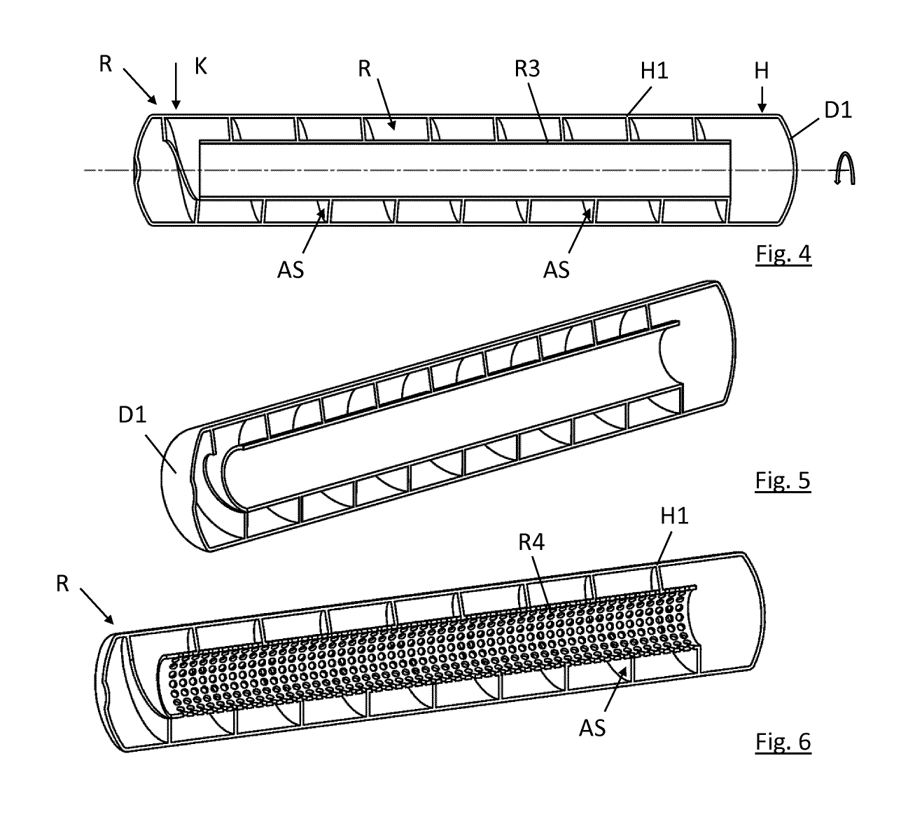

FIGS. 4 and 5 show a further embodiment of a heat conduction tube. The drawings show a cylindrical hollow shaft H1 which is of closed configuration on the end side via cover elements D1. A tubular element is arranged concentrically in the interior of the hollow shaft. The tubular element R3 is arranged in each case spaced apart from the cover elements D1. In each case, as has already been described with respect to FIG. 2, a metal foam or a woven metal fabric is arranged in the end regions, that is to say the hot region and the cold region. This is not shown in the drawings. As can be seen from the sectional illustrations, an Archimedean screw AS is arranged in the annular channel R between the tubular element and the inner wall of the hollow shaft H1. Said screw serves to transport condensate from the cold side to the hot side. In summary, the embodiment which is shown can be used only for slowly rotating shafts. The Archimedean screw for returning the condensate from the cold side to the hot side functions only as long as gravity is greater than the centrifugal forces.

In a modification from the embodiment which is shown in FIGS. 4 and 5, FIG. 6 shows a heat conduction tube, in which the tubular element R4 is designed in a perforated embodiment.

FIG. 3 shows a sectional illustration of a heat conduction disc S1. The latter is configured as a flat, hollow disc-shaped element and is likewise of closed or sealed configuration. The heat conduction disc S1 is also filled with a small quantity of water and has been set at a vacuum. The hot zone H is situated in the outer edge region of the disc with the maximum disc diameter D1. The cold zone or the heat dissipation region is arranged in the region of the rotational axis of the disc. As can be seen from the sectional illustration, metal meshes or metal foams M for increasing the surface area are arranged in the region of the inner wall of the disc-shaped element both in the region of the hot zone H and in the region of the cold zone. This serves for improved heat distribution and uniform distribution of the condensate.

As has already been described with respect to the rotating heat conduction tubes according to FIGS. 2 and 4-6, the condensate is hurled outwards to the hot zone H by way of centrifugal force. There, the condensate is evaporated by way of the introduction of heat via the hot zone, and the steam is displaced in the direction of the cold zone K by the following condensate. In the cold zone, the steam condenses with heat discharge to the metal mesh or the metal foam in the said region and discharge to the outside via the cold zone. As has already been described with respect to the other embodiments, additional plates can also be arranged in the heat conduction disc, which plates delimit the condensate flow and the steam flow.

The above-described heat conduction disc S1 generally serves for heat transport in the radial direction in the case of rotating components. Optional uses are, for example, rotor blades, brake discs, clutch discs, electric motors, turbine rotors and compressor rotors.

In one design variant which is not shown, combinations of heat conduction discs and heat conduction tubes are also possible. Here, the heat can be conducted in a radial direction first of all via a heat conduction disc to a heat conduction tube, and subsequently the heat can be transported and dissipated via the hot zone of a heat conduction tube in the axial direction to the cold zone/heat dissipation region.

### LIST OF REFERENCE SIGNS

R Rotor
ST Stator
W Winding, copper winding
WK Winding head
WN Winding groove
BP Laminated core (stator)
WR Heat conduction tube
KR Cooling ring
KK Cooling channel
MG Motor housing
RB Annular region

1. An electric machine, comprising a stator and a rotatably mounted rotor which is surrounded by the stator, wherein the stator having a laminated core, having a winding groove in the laminated core, which winding groove receives a winding, and at least one cooling ring which adjoins the laminated core in the region of the winding heads, a heat conduction tube in the form of a heat pipe being inserted in the winding groove between the winding and the bottom of the winding groove, the heat conduction tube having at least one heat dissipation region, and the heat dissipation region lying in the region of the cooling ring.

2. The electric machine according to claim 1, wherein the laminated core of the stator is assigned a cooling ring on both sides.

3. The electric machine according to claim 2, wherein the cooling ring has a cooling channel, through which a cooling liquid can flow.

4. The electric machine according to claim 1, wherein the heat dissipation region of the heat conduction tube is in contact with the cooling ring, preferably in an annular region.

5. The electric machine according to claim 1, wherein the rotor includes a rotor shaft having a cavity in the interior filled with a fluid, and wherein the rotor shaft forms a heat conduction tube.

6. The electric machine according to claim 5, wherein the cavity of the rotor shaft has structures on its inner circumference which bring about transport of the fluid by way of the rotation.

7. The electric machine according to either of claim 5, wherein the cavity of the rotor shaft is configured to run conically at least in one section.

8. The electric machine according to claim 5, wherein the cavity of the rotor shaft comprising at least two sections with different diameters.

9. The electric machine according to claim 1, wherein a conical tube is arranged concentrically in a manner which is spaced apart from the conically running inner circumferential face of the rotor shaft.

10. The electric machine according to claim 1, wherein a metal mesh and/or a metal foam is arranged in the inner surface region of the rotor shaft in the region of the cold and hot zone.
